(19) United States
(12) Patent Application Publication
(10) Pub. No.: US 2022/0019370 A1
(43) Pub. Date: Jan. 20, 2022

(54) PARTIAL ZONE MEMORY UNIT HANDLING IN A ZONED NAMESPACE OF A MEMORY DEVICE

(71) Applicant: Micron Technology, Inc., Boise, ID (US)

(72) Inventor: Amit Bhardwaj, Hyderabad (IN)

(21) Appl. No.: 16/930,922

(22) Filed: Jul. 16, 2020

(51) Int. Cl. G06F 3/06

(52) U.S. Cl. CPC G06F 3/0655; G06F 3/0604; G06F 3/0679

(57) ABSTRACT

A request to perform a write operation to write data at a memory device configured with a zoned namespace having multiple zones is received. The data is associated with a zone of the multiple zones of the memory device. The data is stored at a non-zoned memory unit of a non-zoned memory region of the memory device. Whether the amount of data stored at the non-zoned memory unit and associated with the zone satisfies a threshold condition is determined. Responsive to determining that the data stored at the non-zoned memory unit and associated with the zone satisfies the threshold condition, the data is written from the non-zoned memory unit to a zone memory unit of the zone.

### TECHNICAL FIELD

Embodiments of the disclosure relate generally to memory sub-systems, and more specifically, relate to handling a partial zone memory unit in a zoned namespace of a memory device in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure.

FIG. 1 illustrates an example computing system that includes a memory sub-system, in accordance with some embodiments of the disclosure.

FIG. 2 illustrates memory units of a zoned namespace and non-zoned memory region, in accordance with embodiments of the disclosure.

FIG. 3 is a flow diagram of an example method of handling a partial zone memory unit in a zoned namespace of a memory device in a memory sub-system, in accordance with some embodiments of the disclosure.

FIG. 4 is a flow diagram of an example method of handling a partial zone memory unit in a zoned namespace of a memory device in a memory sub-system, in accordance with some embodiments of the disclosure.

FIG. 5 is a block diagram of an example computer system in which embodiments of the disclosure can operate.

### DETAILED DESCRIPTION

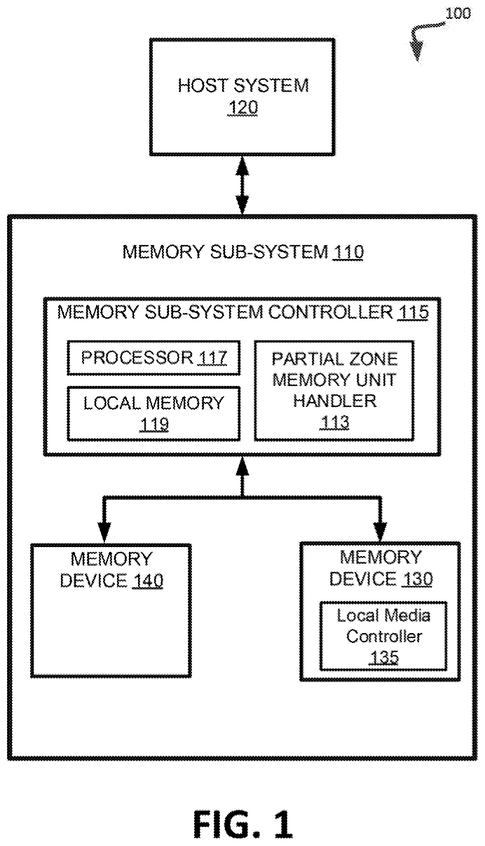

Aspects of the disclosure are directed to handling a partial memory unit in a zoned namespace of a memory device in a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIG. 1. A non-volatile memory device is a package of one or more dies. Each die can consist of one or more planes. For some types of non-volatile memory devices (e.g., NAND devices), each plane consists of a set of physical blocks. Each block consists of a set of pages. Each page consists of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional grid. Memory cells are etched onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types.

Certain memory devices are also configured with a zoned namespace. In a zoned namespace, the address space (e.g., logical block address space) of the memory device (or memory sub-system) is divided into zones which allows for more efficient management of data as the capacity of the memory device increases. For example, each individual zone can be designated for use by a specific client application executed by the host system or some other system with access to the memory device. In a memory device or memory sub-system, one or more zoned namespaces can be implemented, and each zoned namespace can implement one or more zones. A zone can include multiple zone memory units. Each zone can be addressed using a portion of the address space of the memory device or memory sub-system. Data can be written to a particular zone sequentially and independently from other zones.

As used herein, a memory unit can refer to a plane, a block, a page, a cell, a zone, or any other of segment or unit of memory. A partially written memory unit (also referred to as “partial memory unit” herein), such as a partially written zone memory unit, is a memory unit that has not been completely written. For example, a memory unit, such as a block, can be partially written if after writing to the block one or more pages of the block remain unwritten. A memory unit can be closed when the memory unit is completely written. For example, in a closed block all the pages including the last page have been written. A memory unit is open when the memory unit is partially written.

Partially written memory units can exhibit more errors over time than completely written memory units due to the coupling effect. That is, the voltage difference between a wordline of a memory unit that has been written and a wordline of the same memory unit that has not been written can cause changes in threshold voltages of the written memory cells, which can produce bit errors. Further, the coupling effect can produce a greater number of errors the longer a memory unit remains partially written. Moreover, partially written memory units configured to store multiple bits per memory cell can be more susceptible to the coupling effect (e.g., more errors) than memory units configured to store a single bit per memory cell due to the reduced margin between threshold voltages in memory cells that store multiple bits.

Additionally, partially written blocks contribute to extended time to ready (TTR) when the memory sub-system experiences an ungraceful power cycle (e.g., hard power down). Metadata that describes that data stored at the partially written block is reconstructed in the case of an ungraceful power cycle, which contributes to an extended time to ready.

Some conventional systems restrict the number of open blocks used in a memory system. For example, multiple write cursors can be used to locate a block or page that is to be written. Each write cursor can be programmed to allow for only one open block so that the number of partially written blocks does not exceed the number of cursors. However, this can reduce the number of zones that can concurrently have partially written zone memory units, which reduces the efficacy of the zoned namespace scheme.

Aspects of the disclosure address the above and other deficiencies by identifying data that is intended for a zone in the zoned namespace (e.g., is associated with the zone), and temporarily storing that data in a non-zoned memory unit. In some embodiments, the non-zoned memory unit can be single-level cell (SLC) memory and the zone memory units of a zone can be configured as some type of multi-level cell memory. The non-zoned memory units can be memory units that are not part of a zone (e.g., system memory units, such as overprovisioning blocks). The memory sub-system can determine whether an amount of data stored at the non-zoned memory and associated with the zone satisfies a threshold condition. For example, a processing device can determine whether the amount of data stored at the non-zoned memory unit (e.g., one or more blocks of SLC memory) is enough to close a zone memory unit (e.g., block of TLC memory) of the zone. Responsive to determining that the data stored at the non-zoned memory unit satisfies the threshold condition, the data from the non-zoned memory unit is written to the zone memory unit of the zone.

By temporarily storing data to a non-zoned memory unit, and in particular a non-zoned memory unit configured as SLC memory, and migrating data to a zone memory unit configured as some type of multi-level cell memory responsive determining that the amount of data at the non-zoned memory unit satisfies the threshold condition, the memory sub-system reduces the number of partially written zone memory units. This further reduces the number of errors in the memory system and reduces the amount of time allocated to TTR. Non-zoned memory units configured as SLC memory can be more resistant to errors caused by the coupling effect and can have metadata that can be reconstructed in the case of an ungraceful power cycle more quickly than for zone memory units configured as a type of multi-level cell memory.

Additional aspects of the disclosure address the above and other deficiencies by storing the data at a zone memory unit of a zone. Responsive to determining that the zone memory unit is a partially written zone memory unit, the memory sub-system determines whether the amount of time the data is stored at the zone memory unit satisfies a threshold condition. Responsive to determining that the data stored at the zone memory unit satisfies the threshold condition, the data from the partially written zone memory unit is written to a non-zoned memory unit. For example, a clock-based counter can be used to record the time that the data is stored at a partially written zone memory unit. If the data stored at the partially written zone memory unit meets or exceeds a threshold time period, the data from the partially written zone memory unit (configured as a type of multi-level cell memory) can be migrated to a non-zoned memory unit (configured as SLC memory). When new data is to be written to the zone, the new data can be combined with the data stored at the non-zoned memory unit and the combined data can be written to the zoned memory unit and the clock-based counter can be reset.

By storing data to a zone memory unit, and in particular a zone memory unit configured as some type of multi-level cell memory, and migrating the data to a non-zoned memory unit (configured as SLC memory) responsive to storing the data at the zone memory unit for a threshold amount of time, the memory sub-system reduces the amount of time a zone memory unit remains partially written. This, further reduces the number of errors in the memory device or memory sub-system and reduces the amount of time allocated to TTR. Since the time data is stored at a partially written zone memory unit is proportional to the number of errors caused by the coupling effect, reducing the time the data is stored at a partially written zone memory unit reduces the number of errors. Further, migrating the data to non-zoned memory units configured as SLC memory after some time has elapsed rather than indefinitely storing the data at partially written zoned memory units configured as a type of multi-level cell memory further reduces the number of errors since the non-zoned memory units are more resistant to errors caused by the coupling effect. Also, the amount of time allocated for TTR is reduced since metadata for non-zoned memory units can be reconstructed in the case of an ungraceful power cycle more quickly than for zone memory units configured as a type of multi-level cell memory.

FIG. 1 illustrates an example computing system 100 that includes a memory sub-system 110 in accordance with some embodiments of the disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130,140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can be a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

In some embodiments, the memory sub-system 110 includes a partial zone memory unit handler 113 that performs aspects of the disclosure.

In some embodiments, a partial zone memory unit handler 113 receives a request to perform a write operation to write data at a memory device configured with a zoned namespace having multiple zones. The data is associated with a zone of the multiple zones of the memory device. Partial zone memory unit handler 113 stores the data at a non-zoned memory unit of a non-zoned memory region of the memory device. Partial zone memory unit handler 113 determines whether the amount of data stored at the non-zoned memory unit and associated with the zone satisfies a threshold condition. Responsive to determining that the data stored at the non-zoned memory unit and associated with the zone satisfies the threshold condition, partial zone memory unit handler 113 writes the data from the non-zoned memory unit to a zone memory unit of the zone.

In some embodiments, partial zone memory unit handler 113 receives a request to perform a write operation to write data at a memory device configured with a zoned namespace having multiple zones. The data is associated with a zone of the multiple zones of the memory device. Partial zone memory unit handler 113 stores the data at a zone memory unit of the zone of the multiple zones. Responsive to determining that the zone memory unit comprises a partially written zone memory unit, partial zone memory unit handler 113 determines whether an amount of time the data stored at the zone memory unit of the zone satisfies a threshold condition. Responsive to determining that the data stored at the zone memory unit of the zone satisfies the threshold condition, partial zone memory unit handler 113 writes the data from the partially written zone memory unit to a non-zoned memory unit of a non-zoned memory region of the memory device associated with the zone.

In some embodiments, the memory sub-system controller 115 includes at least a portion of the partial zone memory unit handler 113. For example, the memory sub-system controller 115 can include a processor 117 (e.g., a processing device) configured to execute instructions stored in local memory 119 for performing the operations described herein. In some embodiments, the partial zone memory unit handler 113 is part of the host system 110, an application, or an operating system. In other embodiments, local media controller 135 includes at least a portion of the partial zone memory unit handler 113 and is configured to perform the functionality described herein.

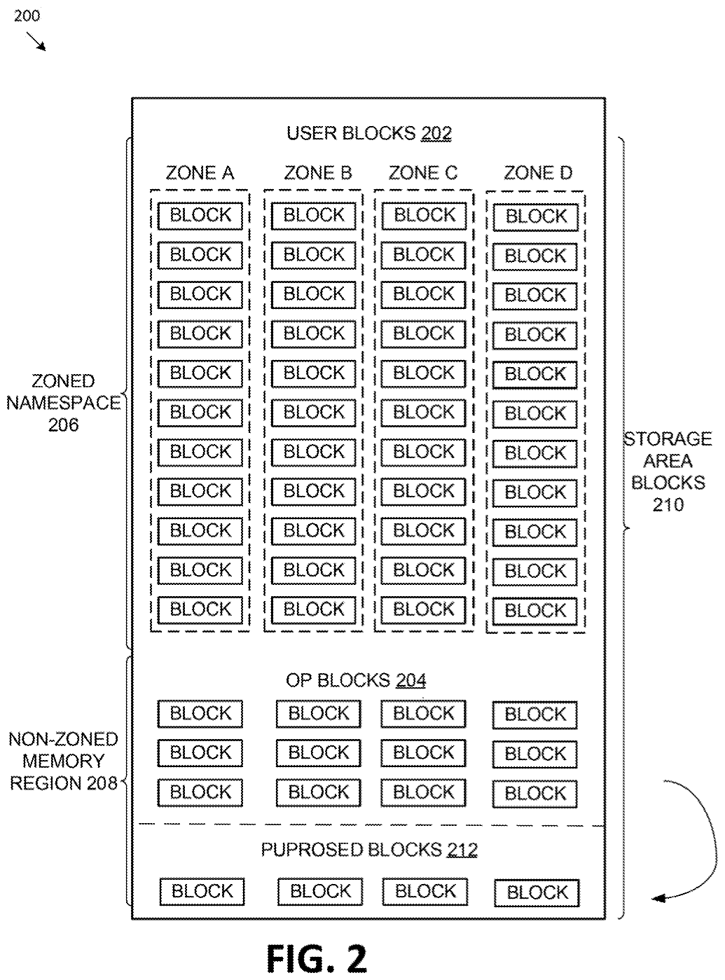

FIG. 2 illustrates memory units of a zoned namespace and non-zoned memory region, in accordance with embodiments of the disclosure. It can be noted that blocks are used as an example of a memory unit and are used for purposes of illustration, rather than limitation. In other embodiments, another unit of memory can be implemented. In some embodiments, a block (or memory unit) is the smallest unit that can be erased at a memory device. A block of the zoned namespace 206 can be an example of a zone memory unit. A block of the non-zoned memory region 208 can be an example of non-zoned memory unit. Diagram 200 can represent the memory units (e.g., storage area blocks 210) of a memory device (e.g., memory device 130) or memory units of a memory sub-system (e.g., memory sub-system 110).

In some embodiments, the storage area blocks 210 can be part of one or more memory devices of memory sub-system 110. Storage area blocks 210 can include a pool of user blocks 202 and a pool of system blocks, such as a pool of over-provisioning (OP) blocks 204. The pool of over-provisioning blocks 204 can include a portion of the storage area blocks 210 and are used for management operations of the memory device 130 or memory sub-system 110. The pool of system blocks can be invisible or not directly accessible by the host system 120 (e.g., not addressable by the host system 120). The pool of user blocks 202 can a portion of the storage area blocks that store user data and are visible and accessible by the host system 120.

In some embodiments, a portion of the storage area blocks 210 can be associated with one or more zoned namespaces, such as zoned namespace 206. A portion of the storage area blocks 210 can be associated with non-zoned memory region 208. For purposes of illustration, rather than limitation, the zoned namespace 206 includes a pool of user blocks 202 and the non-zoned memory region 208 includes a pool of system blocks that include the pool of over-provisioning blocks 204.

In some embodiments, a zoned namespace 206 can include one or more zones. For example, zoned namespace 206 includes zones A-D. Each zone can include one or more blocks. As noted above, the zoned namespace 206 divides the address space of a zoned namespace into zones. Each zone includes blocks (e.g., zone memory units) that are identified by a logical block address (LBA) range that can be written sequentially. In some embodiments, data within a zone cannot be arbitrarily overwritten. To overwrite an already written zone, a zone write pointer is reset, which effectively erases all the data in the zone so that writing to the zone restarts at the beginning of the zone. In some embodiments, each zone is operated independently from the other zones of the zoned namespace 206.

In some embodiments, one or more blocks from a pool of over-provisioning blocks 204 of the memory component are allocated as the purposed blocks 212. The purposed blocks are used to temporarily store data addressed to one or more zones of zoned namespace 206, as described herein. For example, data that is to be stored at zone A, but only fills a partial block of zone A can be written to one or more purposed blocks 212 associated with zone A. In another example, data that is stored at zone A for a threshold amount of time and only fills a partial block of zone A can be written to one or more of the purposed blocks 212 associated with zone A.

In some embodiments, one or more blocks of the purposed blocks 212 can be allocated from the pool of over-provisioning blocks 204 to temporarily store data addressed to a particular zone such that only data for the particular zone is temporarily stored at the corresponding one or more of the purposed blocks 212. In some embodiments, the purposed blocks 212 can be allocated from the pool of over-provisioning blocks 204 to temporarily store data addressed to multiple zones (e.g., any zone) of the zoned namespace 206 such that data for multiple zones is temporarily stored at one or more the purposed blocks 212 (e.g., data for multiple zones can be stored at the same block of the purposed blocks 212). A record (e.g. storing entries having a particular data structure) or metadata associated with the purposed blocks 212 can be used to record which portions of data stored at the purposed blocks 212 are associated with which zones of zoned namespace 206. In some embodiments, the purposed blocks 212 are not blocks assigned to a particular zone. In some embodiments, the purposed blocks are system blocks that are not addressable by the host system 120.

In some embodiments, the blocks associated with one or more zones of zoned namespace 206 include memory cells that are configured to store multiple bits (e.g., MLC, TLC, QLC, etc.). In some embodiments, the purposed blocks 212 are configured as single-level cell memory where memory cells stores a single bit.

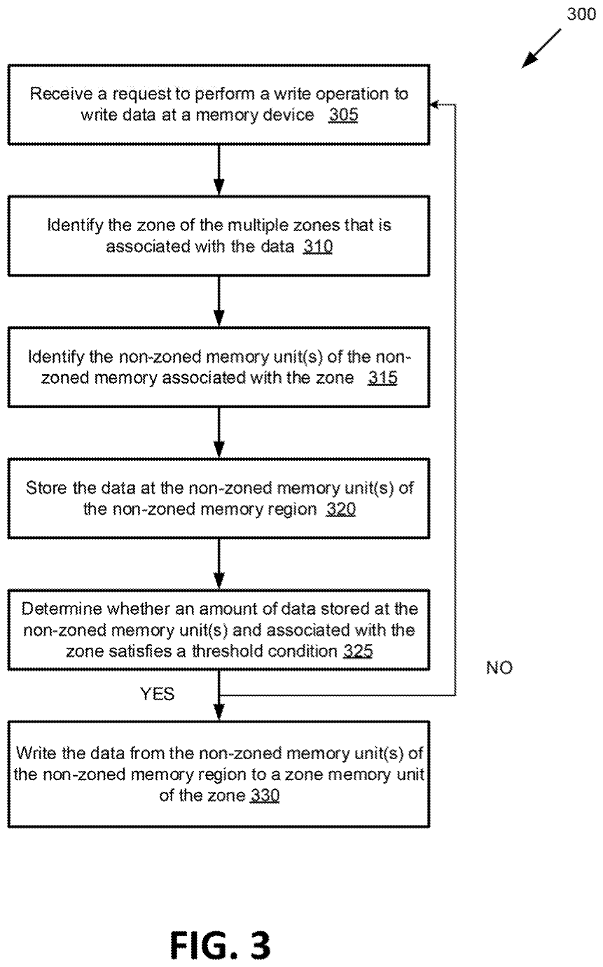

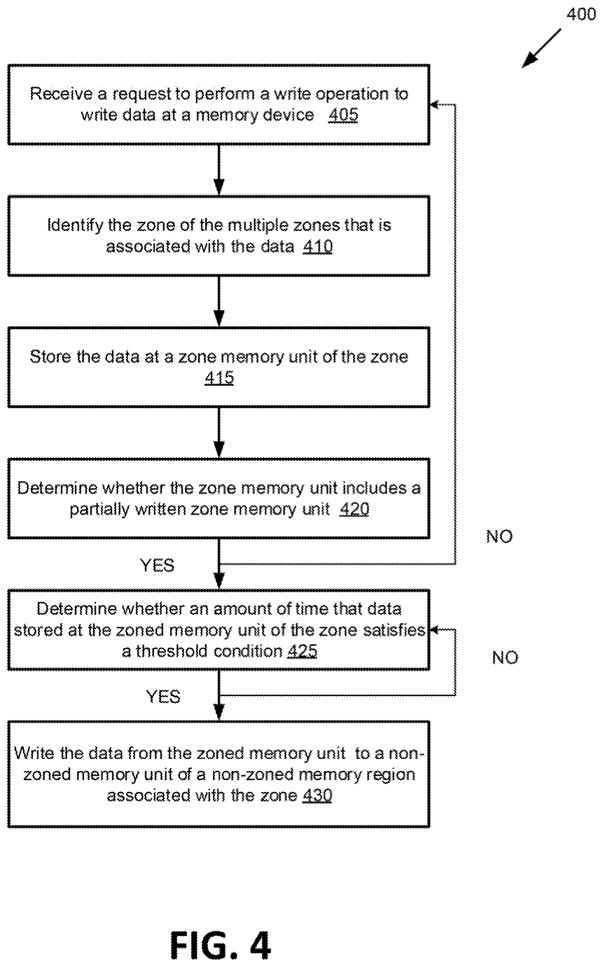

Elements of FIGS. 1-2 can be described below to help illustrate method 300 and method 400 of FIG. 3 and FIG. 4, respectively. Method 300 and 400 can be performed as one or more operations. It can be noted that method 300 or 400 can be performed in any order and can include the same, different, more, or fewer operations.

Method 300 or 400 can performed by processing logic that can include hardware (circuitry, dedicated logic, etc.), software (e.g., instructions run on a processing device), or a combination thereof. In some embodiments, some or all the operations of method 300 or method 400 can be performed by one or more components of system 100 of FIG. 1. In other embodiments, one or more operations of method 300 or 400 can be performed by partial zone memory unit handler 113 as described with respect to FIG. 1.

FIG. 3 is a flow diagram of an example method of handling a partial zone memory unit in a zoned namespace of a memory device in a memory sub-system, in accordance with some embodiments of the disclosure.

At operation 305, processing logic receives a request to perform a write operation to write data at a memory device. In some embodiments, the memory device is configured with a zoned namespace having multiple zones. For example, the memory sub-system can receive a write request from the host system. The write request can include user data that is to be written to the memory sub-system. In some embodiments, the data is associated with a zone of multiple zones of the memory device (or memory sub-system). For example, the write request can identify an LBA or LBA range associated with the data. The LBA or LBA range can be associated with a particular zone.

At operation 310, processing logic identifies the zone of the multiple zones that is associated with the data. In some embodiments, identifying the zone is based on a zone identifier associated with the request to perform the write operation. For example, the LBA or LBA range associated with the write request can be used to identify the particular zone that is associated with the data. For instance, a record that contains entries having a particular data structure can be used to map the identified LBAs to the particular zone that contain the LBAs. In other examples, other zone identifiers can be implemented.

At operation 315, processing logic identifies the non-zoned memory unit(s) of the non-zoned memory region associated with the zone. For example, the particular zone identified by the LBAs can also be associated with one or more non-zoned memory units of the non-zoned memory region. For instance, the record can further map a zone to one or more non-zoned memory units.

In some embodiments, the non-zoned memory unit(s) is allocated from system memory units, such as a pool of over-provisioning memory units. The non-zoned memory unit(s) is to temporarily store the data addressed to the zone. Other non-zoned memory units are allocated from system memory units (e.g., the pool of over-provisioning memory units) to temporarily store other data addressed to another zone of the multiple zones. For example, a particular non-zoned memory unit can temporarily store only data addressed to a particular zone.

In some embodiments, the non-zoned memory units are allocated from system memory units, such as the pool of over-provisioning memory units. The non-zoned memory units temporarily store data addressed to multiple zones. For example, a particular non-zoned memory unit can temporarily store data addressed to a first zone and data addressed to another zone.

At operation 320, processing logic stores the data at the non-zoned memory unit(s) of the non-zoned memory region. In some embodiments, the non-zoned memory unit(s) is configured as single-level cell (SLC) memory.

In some embodiments where the non-zoned memory unit(s) is to temporarily store data addressed to any of the zones, the record can keep an entry that identifies the zone at which the particular data (stored at the non-zoned memory units) is to be written. In other embodiments, metadata associated with the data stored at the non-zoned memory units can identify the zone at which the data is to be written.

In some embodiments, a completion status message can be sent to the host system indicating that the request to perform a write operation has been completed. It can be noted that from the perspective of the host system, the write operation has been completed.

At operation 325, processing logic determines whether an amount of data stored at the non-zoned memory unit(s) and associated with the zone satisfies a threshold condition. If processing logic determines that the threshold condition is satisfied, processing logic proceeds to operation 330. If processing logic determines that the threshold condition is not satisfied, processing logic returns to operation 305. In some embodiments, the zone memory unit(s) includes memory cells that are configured to store multiple bits (e.g., MLC, TLC, QLT, or PLC memory).

In some embodiments, to determine whether the data stored at the non-zoned memory unit and associated with the zone satisfies the threshold condition, processing logic determines whether the amount of data stored at the non-zoned memory unit and associated with the zone includes a threshold amount of data to close the zone memory unit. The threshold amount of data to close the zone memory can include enough data that the entire memory unit can be written (e.g., completed memory unit). For example, the threshold amount of data can include enough data to close a block (e.g., enough data to fill all the wordlines of a block). In another example, if the zoned memory unit is a block and is configured as MLC memory and the non-zoned memory unit is a block and configured as SLC memory, then two full blocks of the non-zoned memory can close a block of zone memory,

In some embodiments, to determine whether the data stored at the non-zoned memory unit and associated with the zone satisfies the threshold condition, processing logic determines whether the amount of data stored at the non-zoned memory unit and associated with the zone includes a threshold amount of data to fill one or more wordlines of the zone memory unit.

In some embodiments, the record can keep track of the amount of data that has been written to the non-zoned memory units for one or more of the zones. The record can be updated responsive to storing new data to the non-zoned memory units or migrating data from the non-zoned memory units to the particular zone memory unit(s).

At operation 330, processing logic writes the data from the non-zoned memory unit(s) of the non-zoned memory region to a zone memory unit of the zone, responsive to determining that the data stored at the non-zoned memory unit and associated with the zone satisfies the threshold condition. In some embodiments, the migration of data from the non-zoned memory unit(s) of the non-zoned memory region to a zone memory unit of the zone can be performed as a background operation. The migration of data is not confirmed to the host (e.g., since the host has already received a confirmation that the data has been written to the memory sub-system). As a background operation, migrating the data can be performed at any time such as at a time that that the memory sub-system can more efficiently process the migration of the data (e.g., during idle time).

FIG. 4 is a flow diagram of an example method of handling a partial memory unit in a zoned namespace of a memory device in a memory sub-system, in accordance with some embodiments of the disclosure.

At operation 405 of method 400, processing logic receives a request to perform a write operation to write data at a memory device. The memory device is configured with one or more zoned namespaces. A zoned namespace includes multiple zone. The data is associated with a zone of the multiple zones of the memory device. At operation 410, processing logic identifies the zone of the multiple zones that is associated with the data. Operation 405 corresponds to operation 305 of method 300. Operation 410 corresponds to operation 310 of method 300. For the sake of brevity, the description associated with operation 305 and 310 is not repeated here. It can be understood that the description of operation 305 and 310 applies to operation 405 and 410, respectively.

At operation 415, processing logic stores the data at the zone memory unit of the zone. In some embodiments, the zone memory unit includes memory cells that are configured to store multiple bits.

At operation 420, processing logic determines whether the zone memory unit includes a partially written zone memory unit. If processing logic determines that the zone memory unit is completely written, processing logic returns to operation 405. If processing logic determines that the zone memory unit is a partially written zone memory unit, processing logic proceeds to operation 425.

In some embodiments, processing logic can determine whether the zone memory unit is partially written or completely written by determining if a last memory sub-unit of the zone memory unit has been written. In some embodiments, the memory sub-unit can include the smallest unit of the memory device 130 that can be written. For example, in instances where the zone memory unit is a block, the memory sub-unit can include a page. In some embodiments, a last memory sub-unit of the zone memory can include a last wordline of the zone memory unit. If the last memory sub-unit has been written, processing logic determines that the zone memory unit has been completely written. If the last memory sub-unit has not been written, processing logic determines that the zone memory unit has been partially written.

At operation 425, processing logic determines whether an amount of time that the data stored at the zone memory unit of the zone satisfies a threshold condition. In some embodiments, to determine whether the data stored at the zone memory unit of the zone satisfies the threshold condition, processing logic determines whether the amount of time the data stored at the zone memory unit meets or exceeds a threshold amount of time. For example, a timer circuit can be used to determine the amount of time elapsed since the data was stored at the zone memory unit. If the time the data has been stored at the zone memory unit does not exceed the threshold amount of time, processing logic, periodically returns to 425 to recheck after some additional time has elapsed. If the time the data has been stored at the zone memory unit meets or exceeds the threshold amount of time, processing logic proceeds to operation 430.

At operation 430, processing logic writes the data from the zoned memory unit to a non-zoned memory unit of a non-zoned memory region associated with the zone (e.g., responsive to determining that the data stored at the zone memory unit of the zone satisfies the threshold condition). In some embodiments, the non-zoned memory unit is configured to as SLC memory.

It can be noted that similar to method 300, the non-zoned memory unit can be used for the particular zone or shared among multiple zones. It can be further noted that the metadata or tables can also be maintained or updated with respect to method 400 in a similar manner as described with respect to method 300.

In some embodiments, the data is stored in the non-zoned memory unit until processing logic receives a new request to perform a new write operation to write new data at the memory device. The new data is associated with the zone (e.g., same zone as the above embodiments of method 400) of the multiple zones of the memory device. In some embodiments, processing logic combines the new data with the data stored at the non-zoned memory unit associated with the zone. In some embodiments, processing logic stores the combined data at the zone memory unit of the zone. In some embodiments, responsive to determining that the zone memory unit storing the combined data includes a partially written zone memory unit, processing logic determines whether the combined data stored at the zone memory unit of the zone satisfies the threshold condition. In some embodiments, responsive to determining that the combined data stored at the zone memory unit of the zone satisfies the threshold condition, processing logic writes the combined data from the partially written zone memory unit to the non-zoned memory unit associated with the zone.

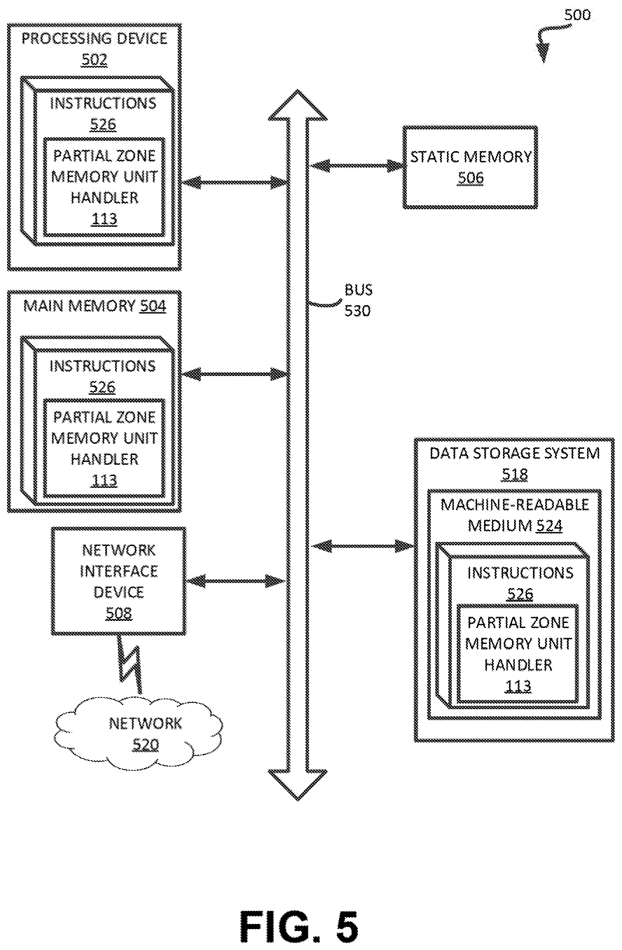

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to partial zone memory unit handler 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to partial zone memory unit handler 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the disclosure is not described with reference to any particular programming language. It will be appreciated that a variety of programming languages can be used to implement the teachings of the disclosure as described herein.

The disclosure can be provided as a computer program product, or software, that can include a machine-readable medium having stored thereon instructions, which can be used to program a computer system (or other electronic devices) to perform a process according to the disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an embodiment” or “one embodiment” or “an implementation” or “one implementation” or the like throughout may or may not mean the same embodiment or implementation. One or more embodiments or implementations described herein may be combined in a particular embodiment or implementation. The terms “first,” “second,” “third,” “fourth,” etc. as used herein are meant as labels to distinguish among different elements and may not necessarily have an ordinal meaning according to their numerical designation.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving a request to perform a write operation to write data at a memory device configured with a zoned namespace having a plurality of zones, wherein the data is associated with a zone of the plurality of zones of the memory device;
storing the data at a non-zoned memory unit of a non-zoned memory region of the memory device;
determining whether an amount of data stored at the non-zoned memory unit and associated with the zone satisfies a threshold condition, wherein the determining comprises: determining whether the amount of data stored at the non-zoned memory unit and associated with the zone comprises a threshold amount of data to close the zone memory unit; and
responsive to determining that the data stored at the non-zoned memory unit and associated with the zone satisfies the threshold condition, writing the data from the non-zoned memory unit to a zone memory unit of the zone.

2. The method of claim 1, wherein the non-zoned memory unit is configured as single-level cell (SLC) memory, and wherein the zone memory unit comprises memory cells that are configured to store multiple bits.

3. (canceled)

4. The method of claim 2, wherein determining whether the data stored at the non-zoned memory unit and associated with the zone satisfies the threshold condition comprises:
determining whether the amount of data stored at the non-zoned memory unit and associated with the zone and comprises a threshold amount of data to fill one or more wordlines of the zone memory unit.

5. The method of claim 1, further comprising:
identifying the zone of the plurality of zones that is associated with the data based on a zone identifier associated with the request to perform the write operation.

6. The method of claim 5, further comprising:
identifying the non-zoned memory unit of the non-zoned memory region allocated from a pool of over-provisioning memory units, wherein the non-zoned memory unit to temporarily store the data addressed to the zone, wherein other non-zoned memory units are allocated from the pool of over-provisioning memory units to temporarily store other data addressed to another zone of the plurality of zones.

7. The method of claim 5, further comprising:
identifying the non-zoned memory unit of the non-zoned memory region allocated from a pool of over-provisioning memory units, wherein the non-zoned memory units are to temporarily store data addressed to any of the plurality of zones.

8-14. (canceled)

15. A system comprising:
a memory device; and
a processing device, operatively coupled with the memory device, to perform operations comprising:
receiving a request to perform a write operation to write data at the memory device configured with a zoned namespace having a plurality of zones, wherein the data is associated with a zone of the plurality of zones of the memory device;
storing the data at a non-zoned memory unit of a non-zoned memory region of the memory device;
determining whether an amount of data stored at the non-zoned memory unit and associated with the zone satisfies a threshold condition, wherein the determining comprises: determining whether the amount of data stored at the non-zoned memory unit and associated with the zone comprises a threshold amount of data to close the zone memory unit; and
responsive to determining that the data stored at the non-zoned memory unit and associated with the zone satisfies the threshold condition, writing the data from the non-zoned memory unit to a zone memory unit of the zone.

16. The system of claim 15, wherein the non-zoned memory unit is configured as single-level cell (SLC) memory, wherein the zone memory unit comprises memory cells that are configured to store multiple bits.

17. (canceled)

18. The system of claim 16, wherein determining whether the data stored at the non-zoned memory unit and associated with the zone satisfies the threshold condition comprises:
determining whether the amount of data stored at the non-zoned memory unit and associated with the zone and comprises a threshold amount of data to fill one or more wordlines of the zone memory unit.

19. The system of claim 15, the processing device to perform further operations comprising:
identifying the zone of the plurality of zones that is associated with the data based on a zone identifier associated with the request to perform the write operation.

20. The system of claim 19, the processing device to perform further operations comprising:
identifying the non-zoned memory unit of the non-zoned memory region allocated from a pool of over-provisioning memory units, wherein the non-zoned memory unit to temporarily store the data addressed to the zone, wherein other non-zoned memory units are allocated from the pool of over-provisioning memory units to temporarily store other data addressed to another zone of the plurality of zones.

21. A non-transitory computer-readable medium comprising instruction that, responsive to execution by a processing device, cause the processing device to perform operations comprising:
receiving a request to perform a write operation to write data at a memory device configured with a zoned namespace having a plurality of zones, wherein the data is associated with a zone of the plurality of zones of the memory device;
storing the data at a non-zoned memory unit of a non-zoned memory region of the memory device;
determining whether an amount of data stored at the non-zoned memory unit and associated with the zone satisfies a threshold condition, wherein the determining comprises: determining whether the amount of data stored at the non-zoned memory unit and associated with the zone comprises a threshold amount of data to close the zone memory unit; and
responsive to determining that the data stored at the non-zoned memory unit and associated with the zone satisfies the threshold condition, writing the data from the non-zoned memory unit to a zone memory unit of the zone.

22. The non-transitory computer-readable medium of claim 21, wherein the non-zoned memory unit is configured as single-level cell (SLC) memory, and wherein the zone memory unit comprises memory cells that are configured to store multiple bits.

23. The non-transitory computer-readable medium of claim 22, wherein determining whether the data stored at the non-zoned memory unit and associated with the zone satisfies the threshold condition comprises:
determining whether the amount of data stored at the non-zoned memory unit and associated with the zone and comprises a threshold amount of data to fill one or more wordlines of the zone memory unit.

24. The non-transitory computer-readable medium of claim 21, the operations further comprising:
identifying the zone of the plurality of zones that is associated with the data based on a zone identifier associated with the request to perform the write operation.

25. The non-transitory computer-readable medium of claim 24, the operations further comprising:
identifying the non-zoned memory unit of the non-zoned memory region allocated from a pool of over-provisioning memory units, wherein the non-zoned memory unit to temporarily store the data addressed to the zone, wherein other non-zoned memory units are allocated from the pool of over-provisioning memory units to temporarily store other data addressed to another zone of the plurality of zones.

26. The non-transitory computer-readable medium of claim 24, the operations further comprising:
identifying the non-zoned memory unit of the non-zoned memory region allocated from a pool of over-provisioning memory units, wherein the non-zoned memory units are to temporarily store data addressed to any of the plurality of zones.
